(19) United States
(12) Patent Application Publication
(10) Pub. No.: US 2006/0239004 A1
(43) Pub. Date: Oct. 26, 2006

(54) Super-short type energy-saving lamp

(76) Inventor: Chun-Tsun Chen, Shanghai (CN)

Correspondence Address: SQUIRE, SANDERS & DEMPSEY L.L.P., 1 MARITIME PLAZA, SUITE 300, SAN FRANCISCO, CA, 94111, US

(21) Appl. No.: 11/400,162

(22) Filed: Apr. 5, 2006

(30) Foreign Application Priority Data
Apr. 6, 2005 (CN) 200510024917.6

(51) Int. Cl. F21S 6/00

(52) U.S. Cl. 362/257

(57) ABSTRACT

The present invention provides a super-short energy-saving lamp wherein the axial length can be smaller than common ones.

### TECHNICAL FIELD

This invention relates to a lighting appliance, in particular a super-short type energy-saving lamp.

### BACKGROUND

The energy-saving lamp is used more and more in daily life. The current energy-saving lamp (as in FIG. 1) generally consists of three parts as follows:
tube 1 for lighting;
the main body 2 containing the circuits
the static plug 3, which is fixed on a wall to hold the lamp.

In FIG. 1, the tube of the energy-saving fluorescent lamp available is a screw type, at the end of which there are two connectors (31, 32) separately connected with two connectors (21, 22) of the main body 2. The radius of the screw tube of energy-saving lamp available is not only almost equivalent to the radius of the main body 2, but also its two connectors (31, 32) need to connect with two connectors (21, 22) of the main body 2 in the its axial direction. Therefore, it increases the whole axial length of the whole energy-saving lamp. The increase of the axial length of the energy-saving lamp not only makes it lack beauty, but also often can not be installed in a smaller room. So people keep reducing its axial length without affecting the function of the energy-saving lamps available.

Therefore, there is a need for a new type short energy-saving lamp.

The embodiments described below address the above-identified need.

### SUMMARY

The present invention is to provide a short energy-saving lamp (e.g., a super-short energy-saving lamp) wherein the axial length is smaller than common ones.

The super-short type of energy-saving lamp provided by this invention comprises the following:
a main body;
a screw lamp tube of energy-saving lamp for lighting connected with the said main body; and
a static plug, connected with the said main body, in which the plug for the energy-saving lamp is plugged.

In the super-short type energy-saving lamp described herein, the inside diameter of the centrical empty part of the tube can be bigger than the outside diameter of the upper-end of the main body, so that part of the upper end of the main body as above can insert into the centrically empty part of the energy-saving tube.

In some embodiments, the connectors of the energy-saving lamp tube as above can be connected with two ends of the main body in the direction of its most outside circumference.

In some embodiments, the axial length of the main body of the super-short energy-saving lamp provided by this invention can be reduced a lot to make the super-short energy-saving lamp with same power become more attractive so as to gain wide acceptance.

### BRIEF DESCRIPTION OF THE DRAWINGS

FIG. 1 is a structural schematic view of existing technical energy-saving lamp model.

FIG. 2 is a structural schematic view of energy-saving lamp model of an embodiment of this invention.

FIG. 3 is a view showing an embodiment of the static plug 3 provided by the present invention.

FIG. 4 is a view showing another embodiment of the static plug 3 provided by the present invention.

### DETAILED DESCRIPTION OF THE EMBODIMENTS

The super-short type of energy-saving lamp provided by this invention generally comprises the following:
a main body;
a screw lamp tube of energy-saving lamp for lighting connected with the said main body; and
a static plug, connected with the said main body, in which the plug for the energy-saving lamp is plugged.

In the super-short type energy-saving lamp described herein, the inside diameter of the centrical empty part of the tube can be bigger than the outside diameter of the upper-end of the main body, so that part of the upper end of the main body as above can insert into the centrically empty part of the energy-saving tube.

In some embodiments, the connectors of the energy-saving lamp tube can be connected with two ends of the main body in the direction of its most outside circumference.

In some embodiments, the axial length of the main body of the super-short energy-saving lamp provided by this invention can be reduced a lot to make the super-short energy-saving lamp with same power become more attractive so as to gain wide acceptance.

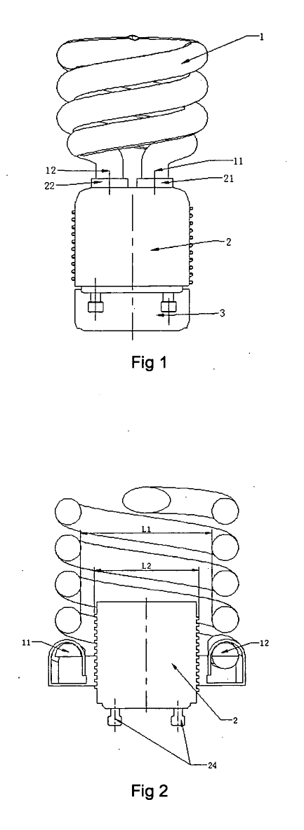

The following embodiments of the present invention are described in reference to FIGS. 2-4.

Referring to FIG. 2, a lamp cap provided by the invention includes an energy-saving tube 1′ for lighting, a main body 2′ and a socket part. The structure of the static plug is similar to the structural model of the available static plug. The tube 1′ for lighting can be a screw type energy-saving lamp tube, which is similar to common screw type energy-saving lamp tube, the distinctness between them being that the radius of screw of energy-saving tube 1′ for lighting is bigger. The main body 2′ can be a column, in which there can be a few circuits (including the circuit of the electrical communtator). The two electrical foots 24 of the main body 2′ can insert into the two holes of the static plug (not drawn in FIG. 2) to connect to the power supply.

Because connector 11 and connector 12 of energy-saving lamp tube can be attached to the two connectors of the main body 2′, which are not drawn in FIG. 1, along the lines of the circumference of energy-saving lamp tube, connector 11 and connector 12 avoid a connection between them along the lines of the axial direction of energy-saving lamp tube, which is the case in the model of existing technology as shown in FIG. 1. It is that connection between them such as the existing technology in FIG. 1 that occupies certain axial dimension of the lamp. In contrast, the connection between the two connectors (connector 11 and connector 12) of this invention can be made not to occupy this axial dimension, so as to shorten the axial size of the lamp.

Furthermore, the inside diameter L1 of the centrical empty part of the energy-saving tube can be bigger than the outside diameter L2 of the upper-end of the main body. Therefore, a part of the upper-end of the main body 2′ can be inserted into the empty room in centrical position of the tube. As a result, the axial size of the main body 2′ can be shorter. Meanwhile, because the radius of the screw type tube can be increased, the screw circles of screw type tube (with the same power) have been reduced. In addition, it can also reduce the axial size of the lamp tube. Thus the axial size of energy-saving lamp can be shortened to a substantial degree. In fact, the lamp of the present invention can be made such that there is only a small distance between the bottom of the main body 2′ and the lower surface of energy-saving lamp tube provided by this invention.

In some embodiments, the main body 2′ of energy-saving lamp of the present invention can have a shape which can be a cube, a cuboid, or a combination of a column and a cube or a cuboid.

In some embodiments, the main body 2′ can be detached such that the technical character of this invention mentioned above, namely, the inside diameter L1 of the centrical empty part of the tube being bigger than the outside diameter L2 of the upper-end of the main body, can also be realized.

Furthermore, in some embodiments, the static plug described above and the main body 2′ can be combined in a lamp.

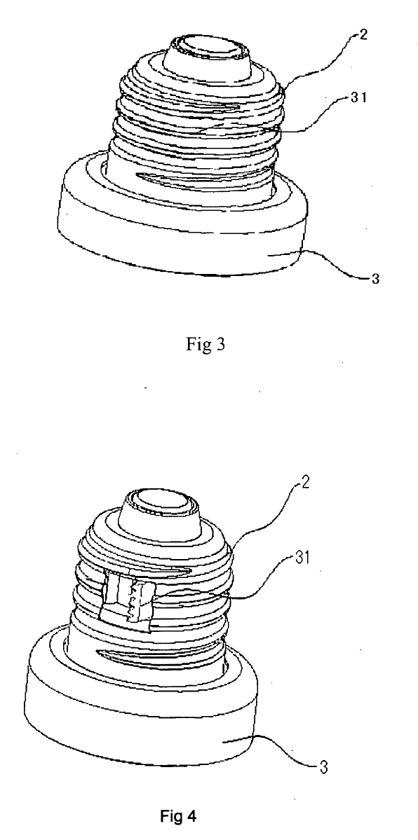

In some embodiments, in order for the energy-saving lamp of this invention to be used use with a common lamp holder, the static plug of this invention can be a connector with the standard screw as shown in FIG. 3 or with the static plug 4 with a non-detachable connector as in FIG. 4. In FIG. 4, with a non-detachable mechanics 31, after installing the energy-saving lamp and turning it tightly, the energy-saving lamp can not be turn out from the opposite direction, thereby avoiding being detached so as to be taken away by others.

While particular embodiments of the present invention have been shown and described, it will be obvious to those skilled in the art that changes and modifications can be made without departing from this invention in its broader aspects. Therefore, the appended claims are to encompass within their scope all such changes and modifications as fall within the true spirit and scope of this invention.

What is claimed:

1. A super-short energy-saving lamp, comprising:
a main body;
a screw lamp tube of energy-saving lamp for lighting connected with the main body via a connector; and
a static plug, connected with the main, in which the plug for the saving-energy lamp is plugged in;

2. The super-short energy-saving lamp of claim 1, wherein the screw lamp tube has a centrical empty part, the inside diameter of which being bigger than the outside diameter of the upper-end of the main body.

3. The super-short energy-saving lamp of claim 1, wherein the connector of the energy-saving lamp tube is connected to two ends of the main body in the direction of its circumference.

4. The energy-saving lamp of claim 3, wherein the said connector of the energy-saving lamp tube is connected to two ends of main body along the lines of the most outside circumference of the tube.

5. The super-short energy-saving lamp of claim 1, wherein said main body is connected with the static plug as a whole.

6. The super-short energy-saving lamp of claim 1, wherein the static plug is a standard screw type.

7. The super-short energy-saving lamp of claim 4, wherein the static plug is equipped with non-detachable mechanics.

8. The super-short energy-saving lamp of claim 1, wherein the main body has a shape which is a cube, a cuboid, or a combination of a column and a cube or a cuboid.
